(19) United States
(12) Patent Application Publication
(10) Pub. No.: US 2021/0006915 A1
(43) Pub. Date: Jan. 7, 2021

(54) SYSTEMS AND METHODS FOR SELECTING AN AUDIO ENDPOINT

(71) Applicant: Microsoft Technology Licensing, LLC, Redmond, WA (US)

(72) Inventor: Uday Sooryakant HEGDE, Issaquah, WA (US)

(21) Appl. No.: 16/460,278

(22) Filed: Jul. 2, 2019

(51) Int. Cl. H04R 29/00; H04N 21/439

(52) U.S. Cl. CPC H04R 29/004; H04R 2420/07; H04N 21/439

(57) ABSTRACT

A method for providing audio information to a user during display of video information includes, at a source device of the user, casting video information to an endpoint display device, identifying a first endpoint audio component of the endpoint display device, comparing one or more capabilities of the first endpoint audio component to one or more capabilities of a second endpoint audio component, selecting the second endpoint audio component as a preferred audio output device based on the comparison, and casting audio information to the preferred audio output device.

### BACKGROUND

### Background and Relevant Art

Audiovisual display devices in daily usage are commonplace. To increase portability of many audiovisual display devices, a video display device and audio device of the audiovisual display device are reduced in size. This reduces volume and mass of the audiovisual display device and also improves the aesthetics of the device but can impair the quality of the video or audio, especially while multiple users are viewing or listening to the device.

Audiovisual display devices commonly rely upon casting video and audio information to other endpoints, such as an external display or external audio speakers, to present information to a user. However, some external video displays lack audio devices or have small or compromised audio devices, themselves. For example, many computer monitors lack any audio devices to play audio provided by a source device.

### BRIEF SUMMARY

In some implementations, a method for providing audio information to a user during display of video information includes, at a source device of the user, casting video information to an endpoint display device, identifying a first endpoint audio component of the endpoint display device, comparing one or more capabilities of the first endpoint audio component to one or more capabilities of a second endpoint audio component, selecting the second endpoint audio component as a preferred audio output device based on the comparison, and casting audio information to the preferred audio output device.

In some implementations, a method for providing audio information to a user during display of video information includes, at a source device of the user, casting video information to an endpoint display device from a source device, identifying a first endpoint audio component associated with the endpoint display device, sending a first test signal request to the first endpoint audio component, receiving a first test audio signal from the first endpoint audio component, sending a second test signal request to a second endpoint audio component, receiving a second test audio signal from the second endpoint audio component, selecting a preferred audio output device by comparing the first test audio signal and the second test audio signal, and casting audio information from the source device to the preferred audio output device.

In some implementations, a source device for communicating video information and audio information to endpoints includes a communication device, a processor, and a hardware storage device. The processor is in data communication with the communication device and the hardware storage device. The hardware storage device has instructions stored thereon that, when executed by the processor, cause the processor to: cast video information to an endpoint display device from the source device using the communication device, identify a first endpoint audio component associated with the endpoint display device, compare the first endpoint audio component to a second endpoint audio component, select a preferred audio output device, and cast audio information from the source device to the preferred audio output device using the communication device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a perspective view of a source device in data communication with a plurality of endpoint devices;

FIG. 2 is a flowchart illustrating a method of presenting audio and video information to a user;

FIG. 3 is a flowchart illustrating a method of presenting audio and video information to a user based on a test audio signal;

FIG. 4-1 is an implementation of an expected waveform;

FIG. 4-2 is an implementation of a received waveform;

FIG. 4-3 is a comparison of the received waveform of FIG. 4-2 and the expected waveform of FIG. 4-1; and

FIG. 5 is a flowchart illustrating a method of presenting audio and video information to a user based on a measured distance.

### DETAILED DESCRIPTION

This disclosure generally relates to devices, systems, and methods for determining an endpoint for audio information to be played from a source device. More particularly, the present disclosure relates to communicating with a plurality of endpoint devices, comparing a potential audio quality from the plurality of endpoint devices, and selecting a preferred audio output device based on user quality.

In some implementations, the source device is in data communication with at least two potential endpoint devices. An endpoint device is an electronic device capable of displaying video information on a display and/or playing audio information through a speaker or similar audio device. In some implementations, the source device is also a potential endpoint device, as a processor of the source device is in data communication with the display and/or speakers of the source device. The source device casts video and/or audio to the endpoint devices to play the video and/or audio for the user(s).

In an example, a user provides input to the source device to display video information on an endpoint display device. In some implementations, the endpoint display device lacks speakers or other audio devices to play associated audio information with the video information. In other implementations, the endpoint display device is in data communication with speakers or other audio devices, but the quality of the speakers or other audio devices is worse than the speaker of the local source or another potential endpoint audio device. In such examples, the source device compares the audio capabilities of the potential endpoint audio devices and casts the audio information to a preferred audio output device based upon the audio quality provided to the user.

In a particular example, a user at a party may want to follow a sporting event (e.g., a football game) by watching on the big screen display in the room and listening to the commentators for the game. However, the group of partygoers nearest to the display may not be interested in the event and may be conversing near the display. In such an example, it is beneficial to the user to have the audio playback at an endpoint audio device nearer to the user, such as the user's personal device or a smart home speaker in the vicinity of the user.

In another example, a conference room is equipped with a large format display and a wireless speaker system. In such an example, a user presenting in the conference room will have the best audio and/or video presentation quality when casting the video to the large format display and casting the corresponding audio to the wireless speaker system. Moreover, the user may not be aware of the capabilities and/or configuration of the audiovisual equipment of the conference room. For example, the user may not know whether the speaker system is in data communication with the large format display or whether the large format display has built-in speakers and the wireless speaker system is independent. Thus, automating the casting decisions, as described herein, is beneficial.

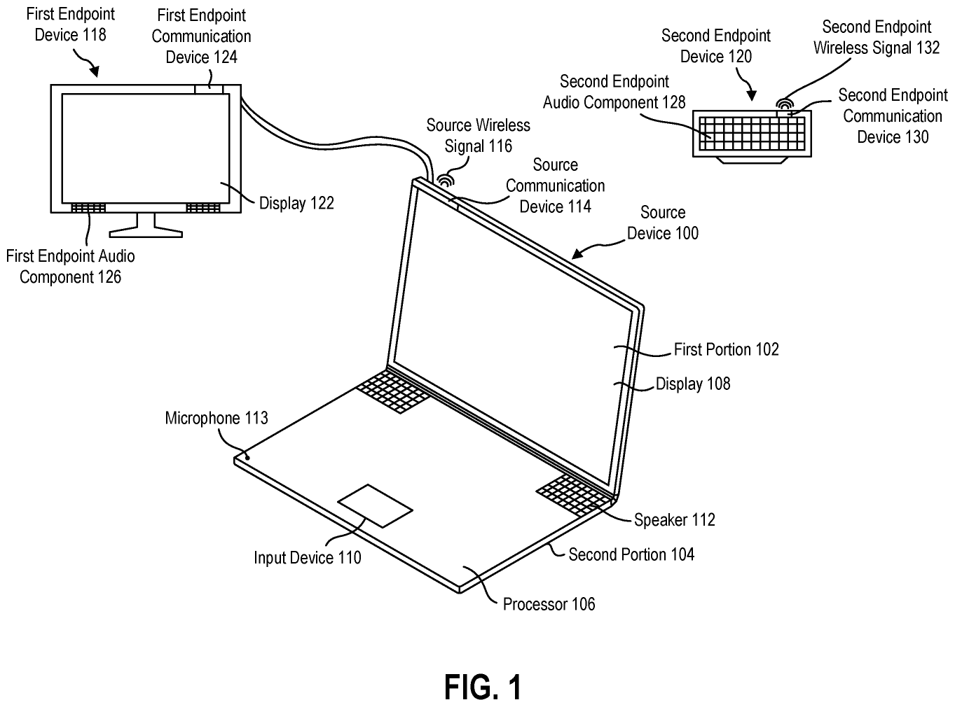

FIG. 1 is a perspective view of a system including a source device 100 casting video information and audio information to a plurality of potential endpoint devices. An endpoint device is a device through which the source device 100 displays video and/or plays audio. The devices are potential endpoint devices, because they have not yet been selected for displaying video and/or playing audio. Once selected, the potential endpoint device(s) become selected endpoint devices. As shown, the endpoint display device is the first endpoint device 118. In other embodiments, the endpoint display device may be another endpoint device.

In some implementations, the source device 100 is a portable electronic device, such as a laptop, a smartphone, a tablet computer, a hybrid computer, a wearable electronic device (e.g., a head-mounted device, a smartwatch, headphones), or other portable electronic device. In other implementations, the source device 100 is an electronic device that is conventionally operated in a fixed location, such as a television, home theater, desktop computer, server computer, projector, optical disc player (e.g., CD player, DVD player, BLURAY player), video game console, or other electronic device.

FIG. 1 illustrates an implementation of a laptop source device 100. The laptop source device 100 includes a first portion 102 and a second portion 104 movably connected to one another. In implementations in which the computing device is a hybrid computer, the first portion 102 includes the display 108 and at least a processor 106. In other implementations, a processor 106 is located in the second portion 104. In some implementations, the first portion 102 of the laptop source device 100 includes a display 108 to present video information to a user and the second portion 104 of the laptop source device 100 includes one or more input devices 110, such as a trackpad, a keyboard, etc., to allow a user to interact with the laptop source device 100. The laptop source device 100 further includes additional computer components, such as system memory, a graphical processing unit, graphics memory, speakers 112, microphone 113, one or more communication devices 114 (such as WIFI, BLUETOOTH, near-field communications, cellular), peripheral connection points, hardware storage device(s), etc. In some implementations, the first portion 102 is removable from the second portion 104. In some implementations, the communication device 114 includes one or more transmitters, receivers, or transceivers.

The electronic components of a laptop source device 100, in particular the display 108, input device 110, processor 106, memory, and batteries, occupy volume and add mass. In the example illustrated in FIG. 1 and in other examples, it is desirable that the electronic devices be thin and light for transport, while remaining powerful and efficient during use. The speakers 112 should generally be powerful and efficient while occupying as little volume of the laptop source device 100 as possible. In some implementations, the speakers 112 can be reduced in size and/or power to save space and energy or improve aesthetics, while compromising audio performance.

In some implementations, the communication device 114 is a wireless communication device. In other implementations, the communication device 114 is a wired communication device. In yet other implementations, the laptop source device 100 has one or more communication devices 114 that provide both wired and wireless data communication with at least one remote endpoint device. For example, the laptop source device 100 may have a communication device 114 that is in wired data communication with a first (potential) endpoint device 118, such as by high definition media interface (HDMI), optical fiber, video graphic array (VGA), or other wired interfaces, and in wireless data communication with a second endpoint device 120, such as by Wi-Fi, BLUETOOTH, or other wireless communication interfaces.

FIG. 1 illustrates an operating environment of a source device 100 and a plurality of potential endpoint devices. The source device 100 can cast video information and/or audio information to different combinations of the potential endpoint devices. Each of the potential endpoint devices includes a potential endpoint display component and/or endpoint audio component. For example, a potential endpoint device that is a desktop computer monitor includes a potential endpoint display component but lacks a potential endpoint audio component. In other examples, a potential endpoint device that is a wireless speaker includes a potential endpoint audio component but lacks a potential endpoint display component. In yet other examples, a potential endpoint device that is a smart television includes both a potential endpoint display component and a potential endpoint audio component. After selecting an endpoint display component, implementations of systems and/or methods described herein allow the selection of an endpoint audio component that may be the same device as the endpoint display device or a different endpoint device.

The first (potential) endpoint device 118, in some implementations, is an endpoint display device. An endpoint display device is any electronic device with a display 122 and a first endpoint communication device 124 that allows video information to be received from another source. For example, the first endpoint communication device 124 allows data communication with the source device 100 to receive video information, which the first endpoint device 118 subsequently presents to a user on the display 122.

In some implementations, the first endpoint device 118 further includes a first endpoint audio component 126, such as built-in speakers in a bezel of the display 122, that allow the first endpoint device 118 to play audio information received from another source. For example, the first endpoint communication device 124 allows data communication with the source device 100 to receive audio information cast from the source device 100, which the first endpoint device 118 subsequently presents to a user by playing through the first endpoint audio component 126.

A second endpoint device 120, in some implementations, includes at least a second endpoint audio component 128 and a second endpoint communication device 130 that allows video information to be received from another source. For example, the second endpoint communication device 130 illustrated in FIG. 1 is a wireless communication device that can receive audio information from the source device 100 through a source wireless signal 116. In some implementations, the second endpoint communication device 130 transmits information back to the source device 100 through a second endpoint wireless signal 132.

In some implementations, the source device 100 is in data communication with at least one remote endpoint device and projects video and audio information to a plurality of endpoint devices. For example, the source device 100 transmits video information to the first endpoint device 118 and audio information to the second endpoint device 120. In the illustrated implementation of FIG. 1, the first endpoint device 118 is the endpoint display device while the second endpoint device 120 is the endpoint audio device. In other implementations, the source device 100 determines the audio quality from the first endpoint audio component 126 of the first endpoint device 118 provides a better user experience, and the first endpoint device 118 includes both the endpoint display component and the endpoint audio component. In yet other implementations, the first endpoint device 118 is the endpoint display component, but the source device 100 plays the audio from the source device speakers 112, acting as the endpoint audio component.

When projecting video information to an endpoint display device remote to the source device 100, the source device 100 measures or determines the relative audio quality or experience for a user from each of the potential endpoint audio component (e.g., first endpoint audio component 126, second endpoint audio component 128, source device speakers 112) and selects a preferred audio output device through which audio is played.

The source device 100 can measure and/or determine the relative audio quality or experience for a user from each of the potential endpoint audio components in different ways. In some implementations, the source device 100 has a hardware storage device in data communication with the processor and/or communication device 114. The hardware storage device has instructions stored thereon that, when executed by the processor, cause the processor to execute any of the methods or parts of the methods described herein. In other implementations, the processor is in data communication with a remotely located hardware storage device, such as via a network.

In some implementations, the hardware storage device is a solid-state storage medium. In some examples, the hardware storage device is a volatile storage medium, such as dynamic random-access memory (DRAM). In other examples, the hardware storage device is a non-volatile storage medium, such as electrically erasable programmable read-only memory or flash memory (NAND- or NOR-type). In other implementations, the hardware storage device is a platen-based storage medium, such as a magnetic platen-based hard disk drive. In yet other implementations, the hardware storage device is an optical storage medium, such as a compact disc, digital video disc, BLURAY disc, or other optical storage format.

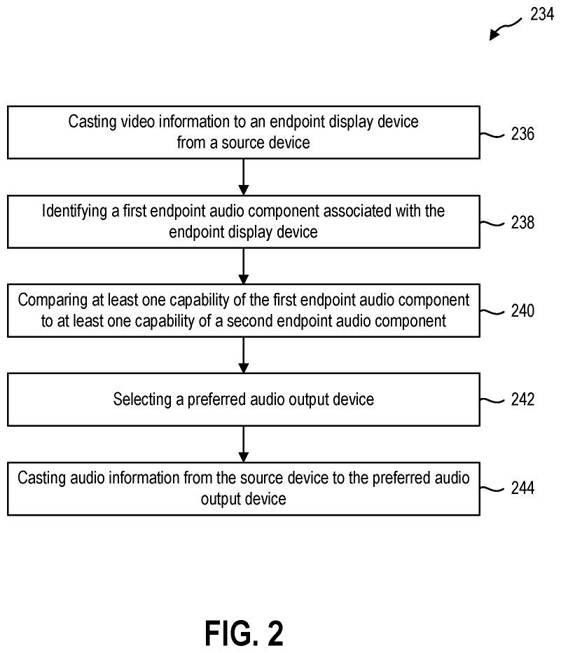

FIG. 2 illustrates an implementation of a method 234 of providing video and audio to a user. The method 234 includes communicating video information to an endpoint display device from a source device at 236. In some implementations, the source device has a video file stored thereon, for example in a hardware storage device, which a processor can access and communicate the video information to the endpoint display device. In other implementations, the source device is in data communication with a video file stored on a remote storage device. For example, the source device can stream a video file from a network and can relay the video information to the endpoint display device.

In some implementations, the video information is associated with and synchronized to audio information. The audio information is played through an endpoint audio component to present the video information and audio information (e.g., for a purpose, such as displaying a presentation with synchronized audio). In some implementations, the audio information is stored and/or accessed from the same location as the video information. For example, the audio information is stored in the same hardware storage device as the video information. In other examples, the audio information is stored in the same file as the video information. In some implementations, the processor parses video information and audio information (e.g., from the same location or file, from different locations or files) and casts the video information and audio information separately.

To play the audio information, the method 234 further includes determining a first endpoint audio component associated with the endpoint display device at 238. In some implementations, the video information and audio information are played by the same endpoint device, such that the endpoint display component and endpoint audio component are associate with the same device. For example, when a video is projected to an external monitor, the audio associated with the video can be played by the speakers of the external monitor. However, in some instances, other endpoint audio components are available that are capable of providing a better audio quality for the user(s). The other potential endpoint audio components are compared to the audio components of the endpoint display device to determine which of the available endpoint audio components is capable of providing a better audio quality for the user(s).

In some implementations, determining the first endpoint audio component associated with the endpoint display device includes transmitting an electronic device identification (EDID) request to the endpoint display device. The EDID request is received by a communication device and/or processor of the endpoint display device, and the endpoint display can return EDID information to the source device. The source device can compare the EDID information from the endpoint display device to a device database that contains device information of display and audio device properties. For example, the source device can compare the EDID information to a table of known electronic devices that contains device information of display and audio device properties.

In a particular example, the endpoint display device is a television in data communication with a home theater that can play audio from one or more sources. The television has a communication device that is in data communication with the source device, while the home theater is not in direct communication with the source device. An EDID request sent to the television (which is in data communication with the home theater) can return EDID information for the television, as well as the home theater. Returning EDID information for both the television and the home theater allows the source device to compare the audio component of the television (built-in speakers) against the audio components of the home theater (e.g., satellite speakers and/or a subwoofer).

In some implementations, the device database is stored locally on a hardware storage device of the source device. In other implementations, the device database is stored remotely on another computing device, and the device databased is accessed by the source device. In such implementations, the source device can send the EDID information to the remote computing device to compare the information and/or download at least a portion of the databased to compare the information. In some implementations, a device database includes display device properties such as resolution, refresh rate, display size, display type (LED, LCD, OLED, etc.); audio device properties such as frequency range, volume range, fidelity, number of channels (2.1, 5.1, 7.1, etc.), audio certifications (Dolby, THX, etc.), power source (e.g., battery powered, battery capacity), communication frequency (WiFi, BLUETOOTH); and other device properties, such as manufacturer, model number, serial number, price, and year of manufacture.

If the endpoint display device is found in the table of known electronic devices, a processor of the source device compares one or more capabilities and/or properties of the first endpoint audio component with one or more capabilities and/or properties of a second endpoint audio component at 240. In some implementations, the second endpoint audio component is the audio component of the source device. In at least one example, the processor of the source device compares at least one device capability and/or property of the first endpoint audio component associated with the endpoint display device to the same device capability and/or property of the second endpoint audio component of the source device.

In some implementations, the capabilities and/or properties of the device are prioritized by the source device selecting the preferred audio output device. For example, the priority order may be frequency range, audio certifications, fidelity, volume range, with other capabilities and/or properties ranked below those capabilities and/or properties.

In other implementations, the second endpoint audio component is another remote audio device that is external to the source device. In an example, the second endpoint audio component is a speaker in wireless data communication with the source device. In other examples, the second endpoint audio component is an external speaker in data communication with the endpoint display device. In a particular example, the endpoint display device is a television in data communication with a home theater that can play audio from one or more sources. The television has a communication device that is in data communication with the source device, while the home theater is not in direct communication with the source device. The source device compares a first endpoint audio component of the television (i.e., the endpoint display device) with the second endpoint audio component of the home theater in communication with the television.

The method 234 further includes selecting a preferred audio output device at 242 and playing audio information from the source device through the preferred (e.g., selected) audio device at 244. In some implementations, the source device searches for a first EDID from the first endpoint audio device (e.g., the television) to a device database and a second EDID from the second endpoint audio device (e.g., a home theater or a BLUETOOTH speaker) to the table (or another table) of known electronic devices. In some implementations, the processor of the source device compares the device capabilities and/or properties of the first endpoint audio component and second endpoint audio component and selects a preferred audio output device based on at least one of the device capabilities and/or properties.

In other implementations, the processor of the source device displays to a user the device capabilities and/or properties of the first endpoint audio component and second endpoint audio component. For example, the device capabilities and/or properties are presented to a user on a display of the source device. In some implementations, the user then selects a preferred audio output device based on at least one of the device capabilities and/or properties identified by the source device and presented to the user by the source device. For example, the user can provide a user input to select one of the potential endpoint audio devices.

A method 334 of presenting audio information to a user, in other implementations, includes measuring at least one device property or audio property of a potential endpoint audio device using the source device. In some implementations, the method 334 includes casting video information to an endpoint display device from the source device at 336 and identifying a first endpoint audio component associated with the endpoint display device at 338, which may be similar to as described in relation to FIG. 2.

In some implementations, the video information and audio information are played by the same endpoint device, such that the endpoint display device and endpoint audio device are the same. For example, when a video is cast to an external monitor, the audio associated with the video can be played by the speakers of the external monitor. However, in some instances, other endpoint audio components are available that are capable of providing a better audio quality for the user(s). The other potential endpoint audio devices are compared to the audio component of the endpoint display device to determine which of the available endpoint audio components is capable of providing a better audio quality for the user(s).

To test the potential endpoint audio components and select a preferred endpoint audio component, a test signal request can be sent to each of the potential endpoint audio devices. The test signal request instructs the potential endpoint audio devices to play a test signal, which is then detected by the source device. The received test signals are compared to an expected test signal and/or against one another to measure audio quality of each potential endpoint audio device at the source device.

In some implementations, the method 334 includes sending a first test signal request to the first endpoint audio component at 346. In some implementations, the first endpoint audio component is the audio component of the endpoint display device. In some examples, the first endpoint audio component is the speakers of a television. In other implementations, the first endpoint audio component is part of a different endpoint audio device. In some examples, the first endpoint audio device is a BLUETOOTH speaker that is not connected to or in communication with the endpoint display device.

The first endpoint audio component plays a first test signal associated with the first test signal request. The method 334 further includes receiving the first test audio signal from the first endpoint audio device at 348. In some implementations, receiving the first test audio signal from the first endpoint audio component includes receiving the first test audio signal with a microphone of the source device. For example, a laptop source device includes a microphone in the housing of the device. In other examples, the source device is a smartphone with a microphone in the device. The microphone of the source device can replicate the location of the user, approximating what the user hears of the audio information played by the first endpoint audio device.

In other implementations, receiving the first test audio signal from the first endpoint audio component includes receiving the first test audio signal with an external microphone in data communication with the source device. For example, the external microphone is in data communication with the source device through the communication device of the source device. In other examples, the external microphone is in data communication with the source device through a peripheral connection port in the source device. A user can position the external microphone in a location away from the source device that replicates the location of the user, approximating what the user hears of the audio information played by the first endpoint audio device. In a particular example, the source device is a laptop that displays video information through a projector. The source device may be located in a different location from the user(s) while the video and audio are played through endpoint devices. In such an example, the microphone of the source device does not approximate the experience of the users, but the external microphone approximates the experience of the users when positioned where the users experience the video and/or audio.

The method 334 further includes sending a second test signal request to the second endpoint audio component at 350. In some implementations, the second endpoint audio component is the audio device of the source device. In some examples, the second endpoint audio component is the speakers of a laptop source device. In other implementations, the second endpoint audio component is a different endpoint audio device. In some examples, the second endpoint audio component is a BLUETOOTH speaker that is not connected to or in communication with the endpoint display device.

The second endpoint audio component plays a second test signal associated with the second test signal request. The method 334 further includes receiving the second test audio signal from the second endpoint audio component at 352. In some implementations, receiving the second test audio signal from the first endpoint audio component includes receiving the second test audio signal with a microphone of the source device. For example, a laptop source device includes a microphone in the housing of the device. In other examples, the source device is a smartphone with a microphone in the device. The microphone of the source device can replicate the location of the user, approximating what the user hears of the audio information played by the first endpoint audio device.

In other implementations, receiving the second test audio signal from the second endpoint audio component includes receiving the second test audio signal with an external microphone in data communication with the source device. For example, the external microphone is in data communication with the source device through the communication device of the source device.

In some implementations, the method 334 includes selecting a preferred audio output device at 354 by comparing the received first test audio signal and the received second test audio signal that are received at the microphone and playing audio information from the source device through the preferred audio output device at 344. For example, a test signal has an expected waveform. The audio information of the test signal that is played by the endpoint audio component and received by the microphone will vary from the expected waveform based on the audio properties of the endpoint audio component and the acoustics of the environment. In some examples, the first endpoint audio component has better hardware specifications than the second endpoint audio component, but the first endpoint audio component is located at a greater distance or at an unfavorable location relative to the microphone that compromises the quality of the received test audio signal.

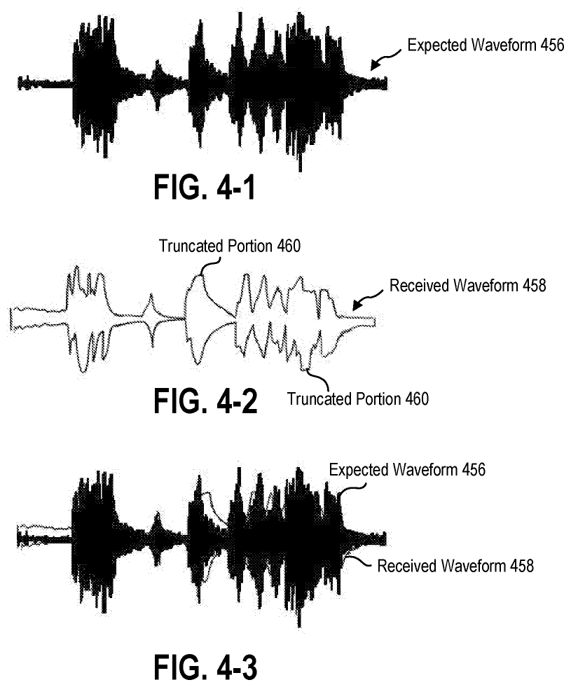

FIG. 4-1 through FIG. 4-3 illustrate an example of comparing waveforms. FIG. 4-1 is an example expected waveform 456 that may be used in some implementations of a method described herein. The expected waveform 456 is the sound that is requested in the test signal request. In some implementations, each of the endpoint audio components attempt to play the expected waveform 456. Depending on the quality and/or capabilities of the endpoint audio component, a received waveform 458, such as shown in FIG. 4-2 will match the expected waveform 456 by a certain amount. The properties of an acoustic path to the microphone (e.g., distance to microphone, angle to the microphone, echo, environmental obstructions) will also affect the received waveform 458. For example, the received waveform 458 is shown with truncated portions 460 of the received waveform 458 that indicate the endpoint audio device is incapable of producing that portion of the expected waveform 456.

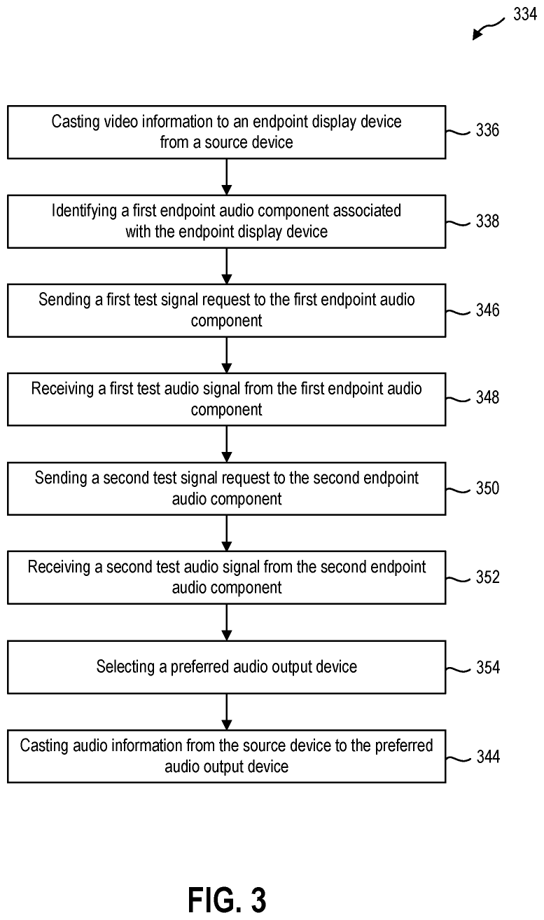

FIG. 4-3 illustrates the expected waveform 456 with the received waveform 458 overlaid. A comparison of the expected waveform 456 and the received waveform 458 allows a calculation of the deviation of the received waveform 458 to quantify the performance of the endpoint audio device. After calculating the difference between the expected waveform 456 and the received waveform for each of the potential endpoint audio component, in some implementations, the endpoint audio component with the smallest difference between the expected waveform 456 and the received waveform 458 is set as the preferred audio output device without any further input from a user. In other implementations, a value representing the difference between the expected waveform 456 and the received waveform 458 for each endpoint audio device is presented to the user, and the user selects the preferred endpoint audio component.

In some implementations, the comparison of the expected waveform 456 and the received waveform 458 identifies a latency and/or delay in the production of the test audio signal. In other implementations, the expected waveform 456 and the received waveform 458 identify audio artifacts or other issues, such as crackling or static in the received waveform 458. Audio artifacts indicate issues with the audio production of the endpoint audio device that will impair the audio associated with the playing of the video information.

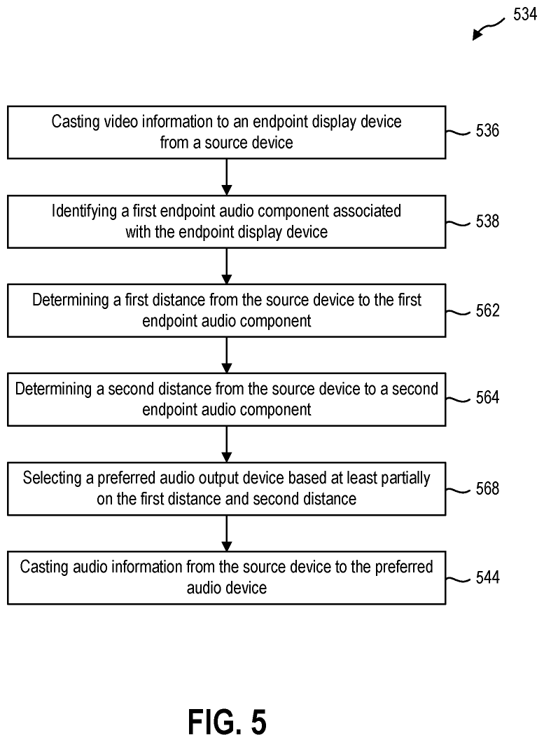

FIG. 5 is a flowchart illustrating another method 534 of presenting audio information to a user. In some implementations, the method 534 of presenting audio information to a user includes measuring at least one device property or audio property of a potential endpoint audio device using the source device. In some implementations, the method 534 includes communicating video information to an endpoint display device from the source device at 536 and determining a first endpoint audio component associated with the endpoint display device at 538, which may be similar to as described in relation to FIG. 2.

In some implementations, the video information and audio information are played by the same endpoint device, such that the endpoint display device and endpoint audio device (containing the endpoint audio component) are the same. For example, when a video is projected to an external monitor, the audio associated with the video can be played by the speakers of the external monitor. However, in some instances, other endpoint audio devices are available that are capable of providing a better audio quality for the user(s). The other potential endpoint audio component are compared to the audio component of the endpoint display device to determine which of the available endpoint audio component is capable of providing a better audio quality for the user(s).

In some implementations, the audio quality of the audio played to the user(s) is at least partially related to a distance between the user(s) and endpoint audio device. A distance between the source device and a potential endpoint audio device is calculated to approximate the distance between the endpoint audio device and the user(s). In some implementations, the method 534 includes determining a first distance from the source device to the first endpoint audio device at 562 and determining a second distance from the source device to the second endpoint audio device at 564.

In some implementations, a distance is measured between the source device and an endpoint audio device by transmitting a wireless communication signal from a source device and measuring a time delay to a response from the endpoint audio device. In some examples, the source device is in data communication with the endpoint audio device with a Wi-Fi connection. An 802.11mc or other Wi-Fi communication protocol can allow the source device to send a ping signal and allow a Wi-Fi Round-Trip-Time (RTT) calculation that can measure a time-of-flight of a data communication. The Wi-Fi RTT calculation can measure a distance between two electronic devices and report to the source device the relative distances to one or more endpoint audio devices.

The method 534 further includes selecting a preferred audio output device based at least partially on the first distance and second distance at 568 calculated by the source device and playing audio information from the source device through the preferred audio output device at 544. In some implementations, the preferred audio output device is selected automatically based upon the first distance and the second distance to select the nearest endpoint audio device without any further input from a user. In other implementations, the preferred audio output device is selected automatically based upon a combination of the distances and a measured audio quality, such as in the method described in relation to FIG. 3. In yet other implementations, the preferred audio output device is selected automatically based upon a combination of the distances and a query of the endpoint audio device and accessing hardware information about the endpoint audio device, such as in the method described in relation to FIG. 2. In further implementations, the distances, audio hardware information, audio test information, other relevant information, or combinations thereof are presented to a user, and the preferred audio output device is selected by the user.

In at least one implementation, the casting information and/or preferred audio output device selection is stored by the source device. In future casting sessions, the source device can identify the potential endpoint devices and recall at least the preferred audio output device without requiring the same testing, comparison, or user selections. For example, each time the user returns to a particular conference room the source device has stored the audio casting information to facilitate reconnection to the preferred audio output device. In other examples, the casting information and/or preferred audio output device selection is stored by a network access point, by the endpoint display device, or by the previously selected preferred audio output device, which then communicates the casting information and/or preferred audio output device selection to the source device.

### INDUSTRIAL APPLICABILITY

This disclosure generally relates to systems and methods of providing audio information to a user while playing video from a source device through an external endpoint display device. In some implementations, the source device is a portable electronic device, such as a laptop, a smartphone, a tablet computer, a hybrid computer, a wearable electronic device (e.g., a head-mounted device, a smartwatch, headphones) or other portable electronic device. In other implementations, the source device is an electronic device that conventionally operated in a fixed location, such as a television, home theater, desktop computer, server computer, projector, optical disc player (e.g., CD player, DVD player, BLURAY player), video game console, or other electronic device.

In implementations in which the computing device is a hybrid computer, the first portion includes the display and at least a processor. In other implementations, a processor is located in a second portion. In some implementations, the first portion of the laptop source device includes a display to present video information to a user and the second portion of the laptop source device includes one or more input devices, such as a trackpad, a keyboard, etc., to allow a user to interact with the laptop source device. The laptop source device further includes additional computer components, such as a hardware storage device, system memory, a graphical processing unit, graphics memory, speakers, one or more communication devices, (such as WIFI, BLUETOOTH, near-field communications, cellular), peripheral connection points, hardware storage device(s), etc. In some implementations, the first portion is removable from the second portion. In some implementations, the communication device includes one or more transmitters, receivers, or transceivers.

The electronic components of a laptop source device, in particular the display, input device, processor, memory, and batteries, occupy volume and add mass. It is desirable that the electronic devices be thin and light for transport, while remaining powerful and efficient during use. The speakers should be powerful and efficient while occupying as little volume of the laptop source device as possible. In some implementations, the speakers can be reduced in size and/or power to save space and energy or improve aesthetics, while compromising audio performance.

In some implementations, the communication device is a wireless communication device. In other implementations, the communication device is a wired communication device. In yet other implementations, the laptop source device has one or more communication devices that provide both wired and wireless data communication with at least one remote endpoint device. For example, the laptop source device has a communication device that is in wired data communication with a first endpoint device, such as by high definition media interface (HDMI), optical fiber, video graphic array (VGA), or other wired interfaces, and in wireless data communication with a second endpoint device, such as by Wi-Fi, BLUETOOTH, or other wireless communication interfaces.

In some implementations, the first endpoint device is an endpoint display device. The endpoint display device is any electronic device with a display and a display communication device that allows video information to be received from another source. For example, the first endpoint communication device allows data communication with the source device to receive video information, which the first endpoint device subsequently presents to a user on the display.

Each of the potential endpoint devices includes a potential endpoint display component and/or endpoint audio component. For example, a potential endpoint device that is a desktop computer monitor includes a potential endpoint display component but lacks a potential endpoint audio component. In other examples, a potential endpoint device that is a wireless speaker includes a potential endpoint audio component but lacks a potential endpoint display component. In yet other examples, a potential endpoint device that is a smart television includes both a potential endpoint display component and a potential endpoint audio component. After selecting an endpoint display component, implementations of systems and/or methods described herein allow the selection of an endpoint audio component that may be the same device as the endpoint display device or a different endpoint device.

In some implementations, the first endpoint device further includes a first endpoint audio component, such as built-in speakers in a bezel of the display, that allow the first endpoint device to play audio information received from another source. For example, the first endpoint communication device allows data communication with the source device to receive audio information, which the first endpoint device subsequently presents to a user by playing through the first endpoint audio device.

In some implementations, a second endpoint device includes at least a second endpoint audio component and a second endpoint communication device that allows video information to be received from another source. For example, the second endpoint communication device is a wireless communication device that can receive audio information from the source device through a source wireless signal. In some implementations, the second endpoint communication device transmits information back to the source device through a second endpoint wireless signal.

In some implementations, the source device is in data communication with at least one remote endpoint device and casts video and audio information to a plurality of endpoint devices. For example, the source device casts video information to the first endpoint device and audio information to the second endpoint device. In some implementations, the first endpoint device is the endpoint display device while the second endpoint device is the endpoint audio device. In other implementations, the source device determines the audio quality from a first endpoint audio component of the first endpoint device provides a better user experience, and the first endpoint device is both the endpoint display device and the endpoint audio device.

In yet other implementations, the first endpoint device is the endpoint display device, but the source device plays the audio from the source device speakers, acting as the endpoint audio device. When casting video information to an endpoint display device remote to the source device, the source device measures or determines the relative audio quality or experience for a user from each of the potential endpoint audio component (e.g., first endpoint audio component, second endpoint audio component, source device speakers) and selects on a preferred audio output device through which audio is played.

The source device can measure and/or determine the relative audio quality or experience for a user from each of the potential endpoint audio components in different ways. In some implementations, the source device has a hardware storage device in data communication with the processor and/or communication device. The hardware storage device has instructions stored thereon that, when executed by the processor, cause the processor to execute any of the methods or parts of the methods described herein. In other implementations, the processor is in data communication with a remotely located hardware storage device, such as via a network.

In some implementations, the hardware storage device is a solid-state storage medium. In some examples, the hardware storage device is a volatile storage medium, such as dynamic random-access memory (DRAM). In other examples, the hardware storage device is a non-volatile storage medium, such as electrically erasable programmable read-only memory or flash memory (NAND- or NOR-type). In other implementations, the hardware storage device is a platen-based storage medium, such as a magnetic platen-based hard disk drive. In yet other implementations, the hardware storage device is an optical storage medium, such as a compact disc, digital video disc, BLURAY disc, or other optical storage format.

A method of providing audio information to a user while playing video on an external endpoint display device includes casting video to an endpoint display device from a source device. In some implementations, the source device has a video file stored thereon, for example in a hardware storage device, which a processor can access and communicate the video information to the endpoint display device. In other implementations, the source device is in data communication with a video file stored on a remote storage device. For example, the source device can stream a video file from a network and can relay the video information to the endpoint display device.

In some implementations, the video information is associated with and synchronized to audio information. The audio information is played through an endpoint audio device to present the video information and audio information to a use. In some implementations, the audio information is stored and/or accessed from the same location as the video information. For example, the audio information is stored in the same hardware storage device as the video information. In other examples, the audio information is stored in the same file as the video information. The processor parses video information and audio information from the file and communicates the video information and audio information separately.

To play the audio information, the method further includes determining a first endpoint audio component associated with the endpoint display device. In some implementations, the video information and audio information are played by the same endpoint device, such that the endpoint display device and endpoint audio device are the same. For example, when a video is projected to an external monitor, the audio associated with the video can be played by the speakers of the external monitor. However, in some instances, other endpoint audio component are available that are capable of providing a better audio quality for the user(s). The other potential endpoint audio component are compared to the audio component of the endpoint display device to determine which of the available endpoint devices is capable of providing a better audio quality for the user(s).

In some implementations, determining the first endpoint audio component associated with the endpoint display device includes transmitting an electronic device identification (EDID) request to the endpoint display device. The EDID request is received by a communication device and/or processor of the endpoint display device, and the endpoint display can return EDID information to the source device. The source device can compare the EDID information from the endpoint display device to a device database that contains device information of display and audio device properties. For example, the source device can compare the EDID information to a table of known electronic devices that contains device information of display and audio device properties.

In a particular example, the endpoint display device is a television in data communication with a home theater that can play audio from one or more sources. The television has a communication device that is in data communication with the source device, while the home theater is not in direct communication with the source device. An EDID request sent to the television (which is in data communication with the home theater) can return EDID information for the television, as well as the home theater. Returning EDID information for both the television and the home theater allows the source device to compare the audio component of the television (built-in speakers) against the audio components of the home theater (e.g., satellite speakers and/or a subwoofer).

In some implementations, the device database is stored locally on a hardware storage device of the source device. In other implementations, the device database is stored remotely on another computing device, and the device databased is accessed by the source device. In such implementations, the source device can send the EDID information to the remote computing device to compare the information and/or download at least a portion of the databased to compare the information. In some implementations, a device database includes display device properties such as resolution, refresh rate, display size, display type (LED, LCD, OLED, etc.); audio device properties such as frequency range, volume range, fidelity, number of channels (2.1, 5.1, 7.1, etc.), audio certifications (Dolby, THX, etc.), power source (e.g., battery powered, battery capacity), communication frequency (WiFi, BLUETOOTH); and other device properties, such as manufacturer, model number, serial number, price, and year of manufacture.

If the endpoint display device is found in the table of known electronic devices, a processor of the source device compares the first endpoint audio component with a second endpoint audio component. In some implementations, the second endpoint audio component is the audio component of the source device. In at least one example, the processor of the source device compares at least one device capability and/or property of the first endpoint audio component associated with the endpoint display device to the same device capability and/or property of the second endpoint audio component of the source device.

In some implementations, the capabilities and/or properties of the device are prioritized by the source device selecting the preferred audio output device. For example, the priority order may be frequency range, audio certifications, fidelity, volume range, with other capabilities and/or properties ranked below those capabilities and/or properties.

In other implementations, the second endpoint audio component is part of another remote audio device that is external to the source device. In an example, the second endpoint audio component is a speaker in wireless data communication with the source device. In other examples, the second endpoint audio component is an external speaker in data communication with the endpoint display device. In a particular example, the endpoint display device is a television in data communication with a home theater that can play audio from one or more sources. The television has a communication device that is in data communication with the source device, while the home theater is not in direct communication with the source device. The source device compares a first endpoint audio component of the television (i.e., the endpoint display device) with the second endpoint audio component of the home theater in communication with the television.

The method further includes selecting a preferred audio output device and playing audio information from the source device through the preferred endpoint audio component. In some implementations, the source device searches for a first EDID from the first endpoint audio device (e.g., the television) to a table of known electronic devices and a second EDID from the second endpoint audio device (e.g., a home theater or a BLUETOOTH speaker) to the table (or another table) of known electronic devices. In some implementations, the processor of the source device compares the device capabilities and/or properties of the first endpoint audio component and second endpoint audio component and selects a preferred audio output device based on at least one of the device capabilities and/or properties.

In other implementations, the processor of the source device displays to a user the device capabilities and/or properties of the first endpoint audio component and second endpoint audio component. For example, the device capabilities and/or properties are presented to a user on a display of the source device. In some implementations, the user then selects a preferred audio output device based on at least one of the device capabilities and/or properties identified by the source device and presented to the user by the source device. For example, the user can provide a user input to select one of the potential endpoint audio component.

In other implementations, a method of presenting audio information to a user includes measuring at least one device capability and/or property or audio property of a potential endpoint audio device using the source device. In some implementations, the method includes casting video information to an endpoint display device from the source device and determining a first endpoint audio component associated with the endpoint display device, which may be similar to as described herein.

In some implementations, the video information and audio information are played by the same endpoint device, such that the endpoint display device and endpoint audio device are the same. For example, when a video is projected to an external monitor, the audio associated with the video can be played by the speakers of the external monitor. However, in some instances, other endpoint audio components are available that are capable of providing a better audio quality for the user(s). The other potential endpoint audio components are compared to the audio component of the endpoint display device to determine which of the available endpoint devices is capable of providing a better audio quality for the user(s).

To test the potential endpoint audio components and select a preferred endpoint audio component, a test signal request can be sent to each of the potential endpoint audio devices. The test signal request instructs the potential endpoint audio components to play a test signal, which is then detected by the source device. The received test signals are compared to an expected test signal and/or against one another to measure audio quality of each potential endpoint audio component at the source device.

In some implementations, the method includes sending a first test signal request to the first endpoint audio component. In some implementations, the first endpoint audio component is the audio component of the endpoint display device. In some examples, the first endpoint audio component is the speakers of a television. In other implementations, the first endpoint audio component is part of a different endpoint audio device. In some examples, the first endpoint audio component is a BLUETOOTH speaker that is not connected to or in communication with the endpoint display device.

The first endpoint audio component plays a first test signal associated with the first test signal request. The method further includes receiving the first test audio signal from the first endpoint audio component. In some implementations, receiving the first test audio signal from the first endpoint audio component includes receiving the first test audio signal with a microphone of the source device. For example, a laptop source device includes a microphone in the housing of the device. In other examples, the source device is a smartphone with a microphone in the device. The microphone of the source device can replicate the location of the user, approximating what the user hears of the audio information played by the first endpoint audio device.

In other implementations, receiving the first test audio signal from the first endpoint audio component includes receiving the first test audio signal with an external microphone in data communication with the source device. For example, the external microphone is in data communication with the source device through the communication device of the source device. In other examples, the external microphone is in data communication with the source device through a peripheral connection port in the source device. A user can position the external microphone in a location away from the source device that replicates the location of the user, approximating what the user hears of the audio information played by the first endpoint audio component. In a particular example, the source device is a laptop that displays video information through a projector. The source device may be located in a different location from the user(s) while the video and audio are played through endpoint devices. In such an example, the microphone of the source device does not approximate the experience of the users, but the external microphone approximates the experience of the users when positioned where the users experience the video and/or audio.

The method further includes sending a second test signal request to the second endpoint audio component. In some implementations, the second endpoint audio component is the audio component of the source device. In some examples, the second endpoint audio component is the speakers of a laptop source device. In other implementations, the second endpoint audio component is part of a different endpoint audio device. In some examples, the second endpoint audio component is a BLUETOOTH speaker that is not connected to or in communication with the endpoint display device.

The second endpoint audio component plays a second test signal associated with the second test signal request. The method further includes receiving the second test audio signal from the second endpoint audio component. In some implementations, receiving the second test audio signal from the second endpoint audio component includes receiving the second test audio signal with a microphone of the source device. For example, a laptop source device includes a microphone in the housing of the device. In other examples, the source device is a smartphone with a microphone in the device. The microphone of the source device can replicate the location of the user, approximating what the user hears of the audio information played by the second endpoint audio component.

In other implementations, receiving the second test audio signal from the second endpoint audio component includes receiving the second test audio signal with an external microphone in data communication with the source device. For example, the external microphone is in data communication with the source device through the communication device of the source device.

In some implementations, the method includes selecting a preferred audio output device by comparing the received first test audio signal and the received second test audio signal that are received at the microphone and playing audio information from the source device through the preferred endpoint audio component. For example, a test signal has an expected waveform. The audio information of the test signal that is played by the endpoint audio component and received by the microphone will vary from the expected waveform based on the audio properties of the endpoint audio component and the acoustics of the environment. In some examples, the first endpoint audio component has better hardware specifications than the second endpoint audio component, but the first endpoint audio component is located at a greater distance or at an unfavorable location relative to the microphone that compromises the quality of the received test audio signal.

An expected waveform is the sound that is requested in the test signal request. Each of the endpoint audio devices attempt to play the expected waveform. Depending on the quality and/or capabilities of the endpoint audio component, a received waveform will match the expected waveform by a certain amount. The properties of an acoustic path to the microphone (e.g., distance to microphone, angle to the microphone, echo, environmental obstructions) will also affect the received waveform. For example, there are truncated or otherwise distorted portions of the received waveform that indicate the endpoint audio component is incapable of producing that portion of the expected waveform.

A comparison of the expected waveform and the received waveform allows a calculation of the deviation of the received waveform to quantify the performance of the endpoint audio component. After calculating the difference between the expected waveform and the received waveform for each of the potential endpoint audio component, in some implementations, the endpoint audio component with the smallest difference between the expected waveform and the received waveform is set as the preferred audio output device without any further input from a user. In other implementations, a value representing the difference between the expected waveform and the received waveform for each endpoint audio device is presented to the user, and the user selects the preferred endpoint audio component.

In some implementations, the comparison of the expected waveform and the received waveform identifies a latency and/or delay in the production of the test audio signal. In other implementations, the expected waveform and the received waveform identify audio artifacts or other issues, such as crackling or static in the received waveform. Audio artifacts indicate issues with the audio production of the endpoint audio device that will impair the audio associated with the playing of the video information.

In some implementations, a method of presenting audio information to a user includes measuring at least one device property or audio property of a potential endpoint audio component using the source device. In some implementations, the method includes casting video information to an endpoint display device from the source device and determining a first endpoint audio component associated with the endpoint display device, which may be similar to as described herein.

In some implementations, the video information and audio information are played by the same endpoint device, such that the endpoint display device and endpoint audio device are the same. For example, when a video is projected to an external monitor, the audio associated with the video can be played by the speakers of the external monitor. However, in some instances, other endpoint audio components are available that are capable of providing a better audio quality for the user(s). The other potential endpoint audio components are compared to the audio component of the endpoint display device to determine which of the available endpoint devices is capable of providing a better audio quality for the user(s).

In some implementations, the audio quality of the audio played to the user(s) is at least partially related to a distance between the user(s) and endpoint audio component. A distance between the source device and a potential endpoint audio component is calculated to approximate the distance between the endpoint audio component and the user(s). In some implementations, the method includes determining a first distance from the source device to the first endpoint audio component and determining a second distance from the source device to the second endpoint audio component.

In some implementations, a distance is measured between the source device and an endpoint audio component by transmitting a wireless communication signal from a source device and measuring a time delay to a response from the endpoint audio component. In some examples, the source device is in data communication with the endpoint audio component with a Wi-Fi connection. An 802.11mc or other Wi-Fi communication protocol can allow the source device to send a ping signal and allow a Wi-Fi Round-Trip-Time (RTT) calculation that can measure a time-of-flight of a data communication. The Wi-Fi RTT calculation can measure a distance between two electronic devices and report to the source device the relative distances to one or more endpoint audio component.

The method further includes selecting a preferred audio output device based at least partially on the first distance and second distance calculated by the source device and playing audio information from the source device through the preferred endpoint audio component. In some implementations, the preferred audio output device is selected automatically based upon the first distance and the second distance to select the nearest endpoint audio component without any further input from a user. In other implementations, the preferred audio output device is selected automatically based upon a combination of the distances and a measured audio quality, such as in the method described herein. In yet other implementations, the preferred audio output device is selected automatically based upon a combination of the distances and a query of the endpoint audio component and accessing hardware information about the endpoint audio component, such as in the method described herein. In further implementations, the distances, audio hardware information, audio test information, other relevant information, or combinations thereof are presented to a user, and the preferred audio output device is selected by the user.

The present disclosure relates to a system and methods for presenting audio and video information to a user according to at least the examples provided in the sections below:
1. A method for providing audio information to a user during display of video information, the method comprising:
   at a source device (e.g., source device 100, FIG. 1) of the user:
      casting (e.g., “casting . . . ” 236, FIG. 2) video information to an endpoint display device (e.g., first endpoint device 118, FIG. 1);
      identifying (e.g., “identifying . . . ” 238, FIG. 2) a first endpoint audio component (e.g., first endpoint audio component 126, FIG. 1) of the endpoint display device;
      comparing (e.g., “comparing . . . ” 240, FIG. 2) one or more capabilities of the first endpoint audio component to one or more capabilities of a second endpoint audio component (e.g., second endpoint audio component 130, FIG. 1);
      selecting (e.g., “selecting . . . ” 242, FIG. 2) the second endpoint audio component as a preferred audio output device based on the comparison; and
      casting (e.g., “casting . . . ” 244, FIG. 2) audio information to the preferred audio output device.
2. The method of section 1, wherein the second endpoint audio component is a source audio component (e.g., speaker 112, FIG. 1) of the source device.
3. The method of section 1 or 2, wherein the selection of the preferred audio output device is automatic based on the comparison and without further user input.
4. The method of any of sections 1-3 further comprising displaying to the user audio quality information for at least one of the first endpoint audio component and the second endpoint audio component.
5. The method of any of sections 1-4 further comprising locating an electronic device identification of the first endpoint audio device in a table of known electronic devices; and obtaining the one or more capabilities of the first endpoint audio device based on the EDID.
6. The method of any of sections 1-5, wherein comparing the one or more capabilities of the first endpoint audio component to one or more capabilities of a second endpoint audio component includes:
   sending (e.g., “sending . . . ” 346, FIG. 3; “sending . . . ” 350, FIG. 3) a test signal request to the first endpoint audio device and the second endpoint audio device,
   receiving (e.g., “receiving . . . ” 348, FIG. 3) a first test audio signal from the first endpoint audio component, receiving (e.g., “receiving . . . ” 352, FIG. 3) a second test audio signal from the second endpoint audio component, and
   comparing (e.g., “selecting . . . ” 354, FIG. 3) the first test audio signal played by the first endpoint audio component to the second test audio signal played by the second endpoint audio component.
7. The method of any of sections 1-6 further comprising recommending preferred audio output device to the user and in response to a user confirmation, initiating audio output at the preferred audio output device.
8. The method of any of sections 1-7 further comprising comparing the first endpoint audio device and the second endpoint audio device to a third endpoint audio device.
9. The method of any of sections 1-8 further comprising receiving audiovisual media, wherein communicating the video information comprises casting a visual portion of the audiovisual media to the display device, wherein communicating the audio information comprises casting an audio portion of the audiovisual media.
10. The method of any of sections 1-9 further comprising determining a first distance from the source device to the first endpoint audio device and a second distance from the source device to the second endpoint audio device.
11. The method of section 10, wherein determining the first distance comprises sending a ping signal to the first endpoint audio device to measure the first distance.
12. A method of providing audio information during presentation of video information, the method comprising:
   at a source device of the user:
      casting (e.g., “casting . . . ” 336, FIG. 3) video information to an endpoint display device from a source device;
      identifying (e.g., “identifying . . . ” 338, FIG. 3) a first endpoint audio component associated with the endpoint display device;
      sending (e.g., “sending . . . ” 346, FIG. 3) a first test signal request to the first endpoint audio component;
      receiving (e.g., “receiving . . . ” 348, FIG. 3) a first test audio signal from the first endpoint audio component;
      sending (e.g., “sending . . . ” 350, FIG. 3) a second test signal request to a second endpoint audio component;
      receiving (e.g., “receiving . . . ” 352, FIG. 3) a second test audio signal from the second endpoint audio component;
      selecting (e.g., “selecting . . . ” 354, FIG. 3) a preferred audio output device by comparing the first test audio signal and the second test audio signal; and
      casting (e.g., “casting . . . ” 356, FIG. 3) audio information from the source device to the preferred audio output device.
13. The method of section 12, wherein the first test signal request contains instructions to play a waveform (e.g., “expected waveform . . . ” 456, FIG. 4-1) and the second test signal request contains instructions to play the same waveform.
14. The method of section 12 or 13, wherein receiving the first test audio signal from the first endpoint audio component includes receiving the first test audio signal (e.g., “received waveform . . . ” 458, FIG. 4-2) with a microphone (e.g., microphone 113, FIG. 1) of the source device.
15. The method of section 14, wherein receiving the second test audio signal from the second endpoint audio component includes receiving the second test audio signal (e.g., “received waveform . . . ” 458, FIG. 4-2) with the microphone (e.g., microphone 113, FIG. 1) of the source device.
16. The method of any of sections 12-15, wherein selecting the preferred audio output device includes comparing a received first waveform of the first test audio signal to an expected waveform of the first test signal request and comparing a received second waveform of the second test audio signal to an expected waveform of the second test signal request.
17. A source device for communicating video information and audio information to endpoints, the device comprising:
   a communication device (e.g., source communication device 114, FIG. 1);
   a processor in data communication with the communication device (e.g., processor 106, FIG. 1); and
   a hardware storage device in data communication with the processor, the hardware storage device having instructions thereon that, when executed by the processor, cause the source device to:
      cast (e.g., “casting . . . ” 236, FIG. 2) video information to an endpoint display device from the source device using the communication device;
      identify (e.g., “identifying . . . ” 238, FIG. 2) a first endpoint audio component associated with the endpoint display device;
      compare (e.g., “comparing . . . ” 240, FIG. 2) the first endpoint audio component to a second endpoint audio component;
      select (e.g., “selecting . . . ” 242, FIG. 2) a preferred audio output device; and
      cast (e.g., “casting . . . ” 244, FIG. 2) audio information from the source device to the preferred audio output device using the communication device.
18. The source device of section 17 further comprising a microphone (e.g., microphone 113, FIG. 1) and the instructions further including sending a test signal request to the first audio endpoint component and receiving a test audio signal with the microphone.
19. The source device of section 18, wherein the microphone is an external microphone outside of a housing of the source device.
20. The source device of any of sections 17-19 further comprising a display (e.g., display 108, FIG. 1) in data communication with the processor, the instructions further including presenting a comparison of the first audio endpoint component and the second audio endpoint component on the display of the source device.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for providing audio information to a user during display of video information, the method comprising:
at a source device of the user:
casting video information to an endpoint display device;
identifying a first endpoint audio component of the endpoint display device;
measuring a first latency in the production of a first test audio signal by the first endpoint audio component;
measuring a second latency in the production of a second test audio signal by a second endpoint audio component selecting a preferred audio output device by comparing at least the first latency of the first test audio signal and the second latency of the second test audio signal; and
casting audio information to the preferred audio output device.

2. The method of claim 1, wherein the second endpoint audio component is a source audio component of the source device.

3. The method of claim 1, wherein the selection of the preferred audio output device is automatic based on the comparison and without further user input.

4. The method of claim 1 further comprising displaying to the user audio quality information for at least one of the first endpoint audio component and the second endpoint audio component.

5. The method of claim 1 further comprising locating an electronic device identification of the first endpoint audio device in a table of known electronic devices; and obtaining the one or more capabilities of the first endpoint audio device based on the electronic device identification.

6. The method of claim 1, wherein comparing the one or more capabilities of the first endpoint audio component to one or more capabilities of the second endpoint audio component includes:
sending a test signal request to the first endpoint audio device and the second endpoint audio device,
receiving a first test audio signal from the first endpoint audio component,
receiving a second test audio signal from the second endpoint audio component, and
comparing the first test audio signal played by the first endpoint audio component to the second test audio signal played by the second endpoint audio component.

7. The method of claim 1 further comprising recommending preferred audio output device to the user and in response to a user confirmation, initiating audio output at the preferred audio output device.

8. The method of claim 1 further comprising comparing the first endpoint audio device and the second endpoint audio device to a third endpoint audio device.

9. The method of claim 1 further comprising receiving audiovisual media, wherein communicating the video information comprises casting a visual portion of the audiovisual media to the endpoint display device, wherein communicating the audio information comprises casting an audio portion of the audiovisual media.

10. The method of claim 1 further comprising determining a first distance from the source device to the first endpoint audio device and a second distance from the source device to the second endpoint audio device.

11. The method of claim 10, wherein determining the first distance comprises sending a ping signal to the first endpoint audio device to measure the first distance.

12. A method of providing audio information during presentation of video information, the method comprising:
at a source device of a user:
casting video information to an endpoint display device from—the source device;
identifying a first endpoint audio component associated with the endpoint display device;
sending a first test signal request to the first endpoint audio component;
receiving a first test audio signal from the first endpoint audio component;
sending a second test signal request to a second endpoint audio component;
receiving a second test audio signal from the second endpoint audio component;
measuring a first latency in the production of the first test audio signal by the first endpoint audio component;
measuring a second latency in the production of the second test audio signal by the second endpoint audio component
selecting a preferred audio output device by comparing at least the first latency of the first test audio signal and the second latency of the second test audio signal; and
casting audio information from the source device to the preferred audio output device.

13. The method of claim 12, wherein the first test signal request contains instructions to play a waveform and the second test signal request contains instructions to play the same waveform.

14. The method of claim 12, wherein receiving the first test audio signal from the first endpoint audio component includes receiving the first test audio signal with a microphone of the source device.

15. The method of claim 14, wherein receiving the second test audio signal from the second endpoint audio component includes receiving the second test audio signal with the microphone of the source device.

16. The method of claim 12, wherein selecting the preferred audio output device includes comparing a received first waveform of the first test audio signal to an expected waveform of the first test signal request and comparing a received second waveform of the second test audio signal to an expected waveform of the second test signal request.

17. A source device for communicating video information and audio information to endpoints, the device comprising:
a communication device;
a processor in data communication with the communication device; and
a hardware storage device in data communication with the processor, the hardware storage device having instructions thereon that, when executed by the processor, cause the source device to:
cast video information to an endpoint display device from the source device using the communication device;
identify a first endpoint audio component associated with the endpoint display device;
measuring a first latency in the production of a first test audio signal by the first endpoint audio component;
measuring a second latency in the production of a second test audio signal by a second endpoint audio component;
selecting a preferred audio output device by comparing at least the first latency of the first test audio signal and the second latency of the second test audio signal;
and
cast audio information from the source device to the preferred audio output device using the communication device.

18. The source device of claim 17 further comprising a microphone to receive the first test audio signal with the microphone.

19. The source device of claim 18, wherein the microphone is an external microphone outside of a housing of the source device.

20. The source device of claim 17 further comprising a display in data communication with the processor, the instructions further including presenting a comparison of the first audio endpoint component and the second audio endpoint component on the display of the source device.
